(19) United States
(12) Patent Application Publication
(10) Pub. No.: US 2008/0281015 A1
(43) Pub. Date: Nov. 13, 2008

(54) Photocurable Composition and Optical Part

(76) Inventors: Satochi Futami, Tokyo (JP); Yoshikazu Yamaguchi, Tokyo (JP); Takayoshi Tanabe, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 10/581,251

(22) PCT Filed: Nov. 29, 2004
(86) PCT No.: PCT/NL04/00828

§ 371 Date: Jun. 13, 2006

(30) Foreign Application Priority Data
Dec. 5, 2003 (JP) 2003-408025

(51) Int. Cl. C08F 283/02; C08L 33/00; C08L 69/00

(52) U.S. Cl. 522/178

(57) ABSTRACT

A photocurable composition comprising the following components (A) to (D):
(A) at least one of the (meth)acrylates having the structures shown by the formulas (1) and (2),

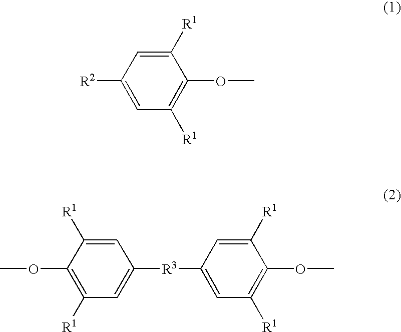

wherein R¹ represents a hydrogen atom or a halogen atom excluding a fluorine atom, R² is a hydrogen atom, a halogen atom excluding a fluorine atom, Ph-C(CH₃)₂—, Ph-, or an alkyl group having 1-20 carbon atoms, and R³ represents —CH₂—, —S—, or —C(CH₃)₂—;
(B) a (meth)acrylate having three or more functional groups, excluding the (meth)acrylates of the component (A);
(C) a radical photoinitiator; and
(D) a polycarbonate polyol having a hydroxyl value of 10-100;
wherein 5-50 wt % of the total acrylic components in the composition are methacrylate compounds. A photocurable composition produces a cured product possessing a high refractive index, excelling in heat resistance, showing only a small amount of warping, and being particularly useful as an optical part such as a prism lens sheet.

### TECHNICAL FIELD

The present invention relates to a photocurable composition. More particularly, the present invention relates to a photocurable composition useful for forming an optical part such as a lens of a prism lens sheet used for a backlight of a liquid crystal display and a Fresnel lens sheet or a lenticular lens sheet used for a screen of a projection TV or a backlight using such a sheet.

### BACKGROUND ART

Conventionally, lenses such as a Fresnel lens and a lenticular lens are manufactured by using a press-forming process or a casting process. However, these processes require a long period of time for manufacturing the lens, thereby resulting in poor productivity. In order to solve this problem, a method of manufacturing lenses using a UV-curable resin has been studied in recent years. In more detail, the method comprises casting a UV-curable resin composition into the space between a mold having a lens shape and a transparent resin substrate and curing the composition by irradiating the side of the substrate with ultraviolet rays, whereby a lens can be manufactured in a short period of time.

However, in the case of using a hard lens sheet, the sheet may warp during production or the lens shape may deform when the lens sheet used at a high temperature of about 60° C. is cooled to room temperature depending on the use conditions. As a result, distortion may occur in the resulting image, as described in Japanese Patent Application Laid-open No. 6-16732.

To provide a lens sheet with heat resistance, a method of increasing the crosslink density in the cured product using a large amount of polyfunctional(meth)acrylate monomers can be given. Such a method has been described in Japanese Patent Application Laid-open No. 2003-48942. Although this method can increase the softening point of the cured products, namely, can improve the heat resistance, the method has a drawback of increasing warping during curing. For this reason, a technology that can provide excellent heat resistance, while inhibiting warping during curing has been desired.

### Problems to be Solved by the Invention

Accordingly, an object of the present invention is to provide a photocurable composition capable of producing a cured product excelling in heat resistance, showing only a small amount of warping, and being particularly useful as an optical part.

### Means for Solving the Problems

The present inventors have conducted extensive studies and found that a photocurable composition comprising at least two types of (meth)acrylates having a specific structure and a radical photoinitiator, wherein 5-50 wt % of the total acrylic components in the composition is a methacrylate compound, produces a cured product showing only a small amount of deformation, excelling in heat resistance, and being particularly useful as an optical part. This finding has led to the completion of the present invention.

Specifically, the present invention provides a photocurable composition comprising the following components (A) to (D):

(A) at least one of (meth)acrylates having structures shown by the following formulas (1) and (2),

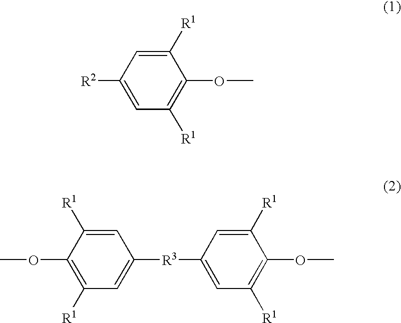

wherein R¹ represents a hydrogen atom or a halogen atom excluding a fluorine atom, R² is a hydrogen atom, a halogen atom excluding a fluorine atom, Ph-C(CH₃)₂—, Ph-, or an alkyl group having 1-20 carbon atoms, and R³ represents —CH₂—, —S—, or —C(CH₃)₂—;
(B) a (meth)acrylate having three or more functional groups, excluding the (meth)acrylates of the component (A);
(C) a radical photoinitiator; and
(D) a polycarbonate polyol having a hydroxyl value of 10-100;
wherein 5-50 wt % of the total acrylic components in the composition are methacrylate compounds; and an optical part obtained by curing the photocurable composition.

### EFFECT OF THE INVENTION

A cured product obtained from the photocurable composition of the present invention excels in heat resistance and shows a small amount of deformation while maintaining a high refractive index. Therefore, the cured product is particularly useful as an optical part such as a prism lens sheet.

### BEST MODE FOR CARRYING OUT THE PRESENT INVENTION

The component (A) used in the present invention is at least one of the (meth)acrylates having the structures shown by the formulas (1) and (2).

As examples of the halogen atom other than a fluorine atom shown by R¹ in the formulas (1) and (2), a chlorine atom, bromine atom, and iodine atom can be given. Of these, a bromine atom is preferable.

As the (meth)acrylate having the structure shown by the formula (1), a compound shown by the following formula (3) is preferable.

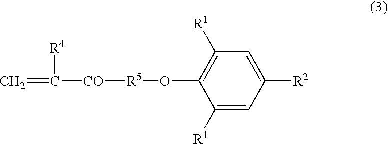

wherein R⁴ represents a hydrogen atom or a methyl group, R⁵ represents —C(OCH₂CH₂)ₘ—, —(OCH₂CH(CH₃))ₙ—, or —OCH₂CH(OH)CH₂—, m and n individually represent an integer from 0 to 10, and R¹ and R² are the same as defined above.

As the (meth)acrylate having the structure shown by the formula (2), a compound shown by the following formula (4) is preferable.

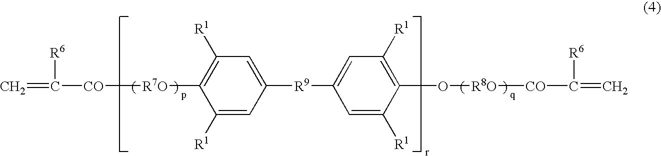

wherein R⁶ represents a hydrogen atom or a methyl group, R⁷ and R⁸ represent —CH₂CH₂—, —CH₂CH(CH₃)—, or —CH₂CH(OH)CH₂—, R⁹ represents —CH₂—, —S—, or —C(CH₃)₂—, p, q, and r are individually an integer from 0 to 10, and R¹ is the same as defined above.

As examples of the (meth)acrylate having the structure shown by the formula (1) of the component (A), phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenylphenyl)-2-hydroxypropyl (meth)acrylate, (meth)acrylate of p-cumylphenol which is reacted with ethylene oxide, 2-bromophenoxyethyl (meth)acrylate, 4-bromophenoxyethyl (meth)acrylate, 2,4-dibromophenoxyethyl (meth)acrylate, 2,6-dibromophenoxyethyl (meth)acrylate, 2,4,6-tribromophenyl (meth)acrylate, 2,4,6-tribromophenoxyethyl (meth)acrylate, and the like can be given. Of these, phenoxyethyl (meth)acrylate, phenoxyethoxyethyl (meth)acrylate, (meth)acrylate of p-cumylphenol reacted with ethylene oxide, 2,4,6-tribromophenoxyethyl (meth)acrylate, and the like are particularly preferable.

As examples of the (meth)acrylate having the structure shown by the formula (2) of the component (A), ethylene oxide addition bisphenol A (meth)acrylate, ethylene oxide addition tetra bromo bisphenol A (meth)acrylate, propylene oxide addition bisphenol A (meth)acrylate, propylene oxide addition tetrabromobisphenol A (meth)acrylate, bisphenol A epoxy (meth)acrylate obtained by an epoxy ring-opening reaction of bisphenol A diglycidyl ether with (meth)acrylic acid, tetrabromobisphenol A epoxy (meth)acrylate obtained by an epoxy ring-opening reaction of tetrabromobisphenol A diglycidyl ether with (meth)acrylic acid, bisphenol F epoxy (meth)acrylate obtained by an epoxy ring-opening reaction of bisphenol F diglycidyl ether with (meth)acrylic acid, tetrabromobisphenol F epoxy (meth)acrylate obtained by an epoxy ring-opening reaction of tetrabromobisphenol F diglycidyl ether with (meth)acrylic acid, and the like can be given. Of these, ethylene oxide addition bisphenol A (meth)acrylate, ethylene oxide addition tetrabromobisphenol A (meth)acrylate, bisphenol A epoxy (meth)acrylate obtained by an epoxy ring-opening reaction of bisphenol A diglycidyl ether with (meth)acrylic acid, tetrabromobisphenol A epoxy (meth)acrylate, and the like are particularly preferable.

As examples of commercially available products of the (meth)acrylate having the structure shown by the formula (1), Aronix M113, M110, M101, M102, M5700, TO-1317 (manufactured by Toagosei Co., Ltd.), Viscoat #192, #193, #220, 3BM (manufactured by Osaka Organic Chemical Industry Co., Ltd.), NK Ester AMP-10G, AMP-20G (manufactured by Shin-Nakamura Chemical Co., Ltd.), Light Acrylate PO-A, P-200A, Epoxy Ester M-600A, Light Ester PO (manufactured by Kyoeisha Chemical Co., Ltd.), New Frontier PHE, CEA, PHE-2, BR-30, BR-31, BR-31M, BR-32 (manufactured by Daiichi Kogyo Seiyaku Co., Ltd.), and the like can be given.

As examples of commercially available products of the (meth)acrylate having the structure shown by the formula (2), Viscoat #700, #540 (manufactured by Osaka Organic Chemical Industry Co., Ltd.), Aronix M-208, M210 (manufactured by Toagosei Co., Ltd.), NK Ester BPE-100, BPE-200, BPE-500, A-BPE-4 (manufactured by Shin-Nakamura Chemical Co., Ltd.), Light Ester BP-4EA, BP-4PA, Epoxy Ester 3002M, 3002A, 3000M, 3000A (manufactured by Kyoeisha Chemical Co., Ltd.), Kayarad R-551, R-712 (manufactured by Nippon Kayaku Co., Ltd.), BPE-4, BPE-10, BR-42M (manufactured by Daiichi Kogyo Seiyaku Co., Ltd.), Ripoxy VR-77, VR-60, VR-90, SP-1506, SP-1507, SP-1509, SP-1563 (manufactured by Showa Highpolymer Co., Ltd.), Neopole V779, Neopole V779MA (manufactured by Japan U-PiCA Co., Ltd.), and the like can be given.

The component (A) may be used either individually or in combination of two or more.

The component (A) is used in the composition in an amount of preferably 40-90 wt %, and particularly preferably 50-80 wt %. The above lower limit of the amount is preferable in view of the refractive index. The above upper limit of the amount is preferable in view of viscosity and heat resistance of the cured product.

The component (B) is a (meth)acrylate having three or more functional groups differing from the component (A). As examples of the (meth)acrylate used as the component (B), (meth)acrylates of an alcohol having three or more hydroxyl groups such as trimethylolpropane tri(meth)acrylate, pentaerythritol tri(meth)acrylate, trimethylolpropane trioxyethyl(meth)acrylate, and tris(2-acryloyloxyethyl)isocyanurate, and the like can be given. These compounds may be used either individually or in combination of two or more.

As examples of commercially available products of these compounds, Aronix M305, M309, M 310, M 315, M 320, M350, M360, M408 (manufactured by Toagosei Co., Ltd.), Viscoat #295, #300, #360, GPT, 3PA, #400 (manufactured by Osaka Organic Chemical Industry Co., Ltd.), NK Ester TMPT, A-TMPT, A-TMM-3, A-TMM-3L, A-TMMT (manufactured by Shin-Nakamura Chemical Co., Ltd.), Light Acrylate TMP-A, TMP-6EO-3A, PE-3A, PE-4A, DPE-6A (manufactured by Kyoeisha Chemical Co., Ltd.), Kayarad PET-30, GPO-303, TMPTA, TPA-320, DPHA, D-310, DPCA-20, DPCA-60 (manufactured by Nippon Kayaku Co., Ltd.), and the like can be given.

The component (B) is used in the composition in an amount of preferably 5-15 wt %, and particularly preferably 5-10 wt %. The above lower limit of the amount is preferable in view of heat resistance of the cured product. The above upper limit of the amount is preferable in view of preventing a decrease in the refractive index.

The component (C) is a radical photoinitiator. As examples of the radical photoinitiator, acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, bis-(2,6-dimethoxybenzoyl)-2,4,4-trimethylpentylphosphine oxide, and the like can be given.

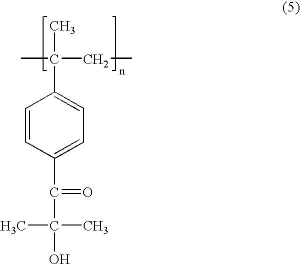

wherein n is an integer of 1-5.

As examples of commercially available products of the radical photoinitiator, Irgacure 184, 369, 651, 500, 819, 907, 784, 2959, CGI1700, CGI1750, CGI11850, CG24-61, Darocure 116, 1173 (manufactured by Ciba Specialty Chemicals Co., Ltd.), Lucirin LR8728 (manufactured by BASF), Ubecryl P36 (manufactured by UCB), KIP150 (manufactured by Lamberti Co.), and the like can be given. Among these, Irgacure184 and KIP150 and KIP150 are preferable, with KIP150 being particularly preferable to improve heat resistant and reduce warping.

The component (C) is used in the composition in an amount of preferably 0.01-10 wt %, and particularly preferably 0.5-7 wt %. The above upper limit of the amount is preferable in view of ensuring cure characteristics of the composition, mechanical characteristics and optical characteristics of the cured product, handling capability, and the like. The above lower limit of the amount is preferable for preventing a decrease in the cure speed.

The component (D) is a polycarbonate polyol having a hydroxyl value of 100 or less and is commercially available under the trade name PLACCEL CD220PL (manufactured by Daicel Chemical Industries, Ltd.), for example. Polyols other than polycarbonate polyols, such as a polyether polyol and polyester polyol, produce cured-products having insufficient heat resistance and exhibiting increased warping.

The hydroxyl value of the component (D) must be in the range of 10-100, preferably 20-80, and more preferably 40-70. If the hydroxyl value is outside the range of 10-100, the cured products may have poor heat resistance and exhibit increased warping. The hydroxyl value is measured according to ASTM standard ASTM D 4274-94, which standard can be found on http://www.astm.org/cgi-bin/SoftCart.exe/DATABASE.CART/REDLINE_PAGES/E1899.htm?E+mystore

Although there are no specific limitations to the molecular weight of the component (D), the cured products may have poor heat resistance if the molecular weight of the component (D) is too small. If the molecular weight is too large, the viscosity of the component (D) becomes too high to be handled with ease. For these reasons, the polystyrene-reduced weight average molecular weight of the component (D) determined by gel permeation chromatography is preferably between 2,000 and 10,000.

The content of the component (D) in the composition is 1-10 wt %, and particularly preferably 1-4 wt %. If the content of the component (D) exceeds 10 wt %, the refractive index of the cured products may decrease; if less than 1 wt %, sufficient heat resistance may not be obtained and warping may increase during the curing process.

The composition of the present invention may further include a photosensitizer. As examples of the photosensitizer, triethylamine, diethylamine, N-methyldiethanoleamine, ethanolamine, 4-dimethylaminobenzoic acid, methyl 4-dimethylaminobenzoate, ethyl 4-dimethylaminobenzoate, isoamyl 4-dimethylaminobenzoate, and the like can be given. As commercially available products of the photosensitizer, Ubecryl P102, 103, 104, and 105 (manufactured by UCB), and the like can be given.

In the present invention, a compound having a (meth)acryloyl group or a vinyl group other than the components (A) to (D) may be used as an optional component (hereinafter called “unsaturated monomer”). As the unsaturated monomer, vinyl monomers such as N-vinylpyrrolidone, N-vinylcaprolactam, vinylimidazole, and vinylpyridine, isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone(meth)acrylamide, isobutoxymethyl(meth)acrylamide, N,N-dimethyl(meth)acrylamide, t-octyl(meth)acrylamide, dimethylaminoethyl (meth)acrylate, diethylaminoethyl (meth)acrylate, 7-amino-3,7-dimethyloctyl (meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, and monofunctional monomers shown by following formulas (6) and (7) can be given.

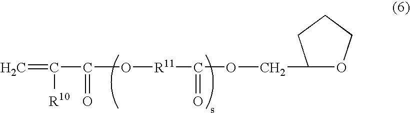

wherein R¹⁰ represents a hydrogen atom or a methyl group, R¹¹ represents an alkylene group having 2-8 carbon atoms, and s is an integer from 0 to 8;

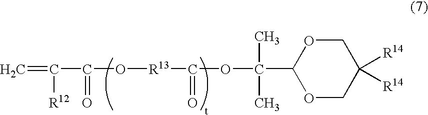

wherein R¹² and R¹⁴ individually represent a hydrogen atom or a methyl group, R¹³ represents an alkylene group having 2 to 8 carbon atoms, and t is an integer from 1 to 8.

Further examples include unsaturated monomers having two (meth)acryloyl groups or two vinyl groups in the molecules such as an alkyldiol diacrylate such as 1,4-butanediol diacrylate, 1,6-hexanediol diacrylate, and 1,9-nonanediol diacrylate, polyalkylene glycol diacrylate such as ethylene glycol di(meth)acrylate, tetraethylene glycol diacrylate, and tripropylene glycol diacrylate, neopentyl glycol di(meth)acrylate, and tricyclodecanemethanol diacrylate. Of these, acryloylmorpholine, N-vinylpyrrolidone, N-vinylcaprolactam, 1,6-hexanediol diacrylate, 1,9-nonanediol diacrylate, and the like are particularly preferable.

The composition of the present invention may further include a urethane (meth)acrylate oligomer. As examples of the urethane (meth)acrylate, polyether polyols such as polyethylene glycol and polytetramethyl glycol; polyester polyols obtained by the reaction of a dibasic acid such as succinic acid, adipic acid, azelaic acid, sebacic acid, phthalic acid, tetrahydrophthalic acid (anhydride), hexahydrophthalic acid (anhydride) with a diol such as ethylene glycol, propylene glycol, diethylene glycol, triethylene glycol, tetraethylene glycol, dipropylene glycol, 1,4-butanediol, 1,6-hexanediol, and neopentyl glycol; poly ε-caprolactone-modified polyol; polymethylvalerolactone-modified polyol; ethylene glycol, propylene glycol, 1,4-butanediol, and 1,6-hexanediol; alkyl polyols such as neopentyl glycol; bisphenol A skeleton alkylene oxide modified polyols such as ethylene oxide addition bisphenol A and propylene oxide addition bisphenol A; bisphenol F skeleton alkylene oxide modified polyols such as ethylene oxide addition bisphenol F and propylene oxide addition bisphenol F; urethane (meth)acrylate oligomers prepared from a mixture of these, an organic polyisocyanate such as tolylene diisocyanate, isophorone diisocyanate, hexamethylene diisocyanate, diphenylmethane diisocyanate, and xylylene diisocyanate, and a hydroxyl-group-containing (meth)acrylate such as 2-hydroxyethyl (meth)acrylate and 2-hydroxypropyl (meth)acrylate; and the like can be given. Use of the urethane (meth)acrylate oligomer is preferable in order to maintain the viscosity of the curable composition of the present invention at a moderate level. The urethane (meth)acrylate oligomer is used in the curable composition of the present invention in an amount of preferably 4.99-40 wt %, and still more preferably 4.99-20 wt %.

As examples of commercially available products of monomers of the urethane (meth)acrylate oligomer, Aronix M 120, M-150, M-156, M-215, M-220, M-225, M-240, M-245, M-270 (manufactured by Toagosei Co., Ltd.), AIB, TBA, LA, LTA, STA, Viscoat #155, IBXA, #158, #190, #150, #320, HEA, HPA, #2000, #2100, DMA, #195, #230, #260, #215, #335HP, #310HP, #310HG, #312 (manufactured by Osaka Organic Chemical Industry Co., Ltd.), Light Acrylate IAA, L-A, S-A, BO-A, EC-A, MTG-A, DMP-A, THF-A, IB-XA, HOA, HOP-A, HOA-MPL, HOA-MPE, 3EG-A, 4EG-A, 9EG-A, NP-A, 1,6HX-A, DCP-A (manufactured by Kyoeisha Chemical Co., Ltd.), Kayarad TC-110S, HDDA, NPGDA, TPGDA, PEG400DA, MANDA, HX-220, HX-620 (manufactured by Nippon Kayaku Co., Ltd.), FA-511A, 512A, 513A (manufactured by Hitachi Chemical Co., Ltd.), VP (manufactured by BASF), ACMO, DMAA, DMAPAA (manufactured by Kohjin Co., Ltd.), and the like can be given.

The urethane (meth)acrylate oligomer is obtained as a reaction product of (a) a hydroxyl group-containing (meth)acrylate, (b) an organic polyisocyanate, and (c) a polyol. The urethane (meth)acrylate oligomer is preferably a reaction product obtained by reacting the hydroxyl group-containing (meth)acrylate (a) with the organic polyisocyanate (b), and reacting the resulting product with the polyol (c).

The curable composition of the present invention contains the methacrylate compound in an amount of 5-50 wt %, preferably 10-40 wt %, and still more preferably 15-40 wt % of the total acrylic components in the composition. If the content of the methacrylate compound is 5 wt % or more, heat resistance is increased. If the content is 50 wt % or less, warping during curing is prevented. The total acrylic components refer to the total amount of the acrylate compound and the methacrylate compound. The total acrylic components herein include urethane acrylate oligomers and urethane methacrylate oligomers, but exclude vinyl monomers among unsaturated monomers.

In addition to the above components, additives such as antioxidants, UV absorbers, light stabilizers, silane coupling agents, coating surface improvers, heat-polymerization inhibitors, leveling agents, surfactants, coloring agents, preservatives, plasticizers, lubricants, solvents, fillers, aging preventives, wettability improvers, and release agents may optionally be added.

Examples of antioxidants include Irganox1010, 1035, 1076, 1222 (manufactured by Ciba Specialty Chemicals Co., Ltd.), Antigene P, 3C, FR, Sumilizer GA-80 (manufactured by Sumitomo Chemical Industries Co., Ltd.), and the like; examples of UV absorbers include Tinuvin P, 234, 320, 326, 327, 328, 329, 213 (manufactured by Ciba Specialty Chemicals Co., Ltd.), Seesorb 102, 103, 110, 501, 202, 712, 704 (manufactured by Sypro Chemical Co., Ltd.), and the like; examples of light stabilizers include Tinuvin 292, 144, 622LD (manufactured by Ciba Specialty Chemicals Co., Ltd.), Sanol LS770 (manufactured by Sankyo Co., Ltd.), Sumisorb TM-061 (manufactured by Sumitomo Chemical Industries Co., Ltd.), and the like; examples of silane coupling agents include g-aminopropyltriethoxysilane, g-mercaptopropyltrimethoxy-silane, and g-methacryloxypropyltrimethoxysilane, and commercially available products such as SH6062, SH6030 (manufactured by Toray-Dow Corning Silicone Co., Ltd.), and KBE903, KBE603, KBE403 (manufactured by Shin-Etsu Chemical Co., Ltd.); examples of coating surface improvers include silicone additives such as dimethylsiloxane polyether and commercially available products such as DC-57, DC-190 (manufactured by Dow-Corning), SH-28PA, SH-29PA, SH-30PA, SH-190 (manufactured by Toray-Dow Corning Silicone Co., Ltd.), KF351, KF352, KF353, KF354 (manufactured by Shin-Etsu Chemical Co., Ltd.), and L-700, L-7002, L-7500, FK-024-90 (manufactured by Nippon Unicar Co., Ltd.). As a releasing agent, PRISURF A208F (manufactured by Daiichi Kogyo Seiyaku Co., Ltd.) and the like can be given.

The composition of the present invention may be prepared by mixing the above components using a conventional method. Viscosity of the composition of the present invention prepared in this manner is usually 200-50,000 cp/25° C., and preferably 500-30,000 cp/25° C. If the viscosity of the composition is too great, coating may become uneven or swelling may occur when forming a lens, or a desired thickness of the lens may not be obtained, whereby performance of the lens may be insufficient. If the viscosity is too low, it is difficult to control the thickness of the lens, whereby a lens having a uniform thickness may not be formed.

It is particularly preferable that a cured product obtained by curing the composition of the present invention by applying radiation have the following properties. The refractive index of the cured product at 25° C. is preferably 1.55 or more, and still more preferably 1.56 or more. If the refractive index is less than 1.55, sufficient frontal brightness may not be secured when forming a prism lens sheet using the composition of the present invention.

The softening point of the cured product is preferably 40° C. or more, and particularly preferably 50° C. or more. If the softening point of the cured product is less than 40° C., heat resistance may be insufficient.

The invention also relates to an optical part obtained by curing the photocurable compositions according to the invention.

### EXAMPLES

The present invention is described below in more detail by examples. However, the present invention is not limited to these examples.

### Examples 1-2 and Comparative Examples 1-4

A reaction vessel was charged with the components shown in Table 1. The mixture was stirred at 50-60° C. for one hour to obtain a curable liquid resin composition having a viscosity of 500-10,000 cps/25° C. The unit of each component shown in Table 1 is “part by weight”.

The urethane acrylate in Table 1 was synthesized by the following method. A reaction vessel equipped with a stirrer was charged with 35.47 wt % of 2,4-tolylene diisocyanate, 0.08 wt % of di-n-butyltin dilaurate, and 0.02 wt % of 2,6-di-t-butyl-p-cresol. 23.65 wt % of 2-hydroxyethyl acrylate was added dropwise while stirring while maintaining the temperature at 30° C. or lower. After the addition, the mixture was allowed to react at 30° C. for one hour. After the addition of 40.77 wt % of bisphenol A ethylene oxide addition diol (number of ethylene oxide structural units=4; average molecular weight=400), the mixture was allowed to react at 50-70° C. for two hours. The reaction was terminated when the residual isocyanate was 0.1 wt % or less.

### Evaluation Method

### 1. Measurement of Refractive Index

The curable liquid resin composition was applied onto a glass plate using an applicator bar and irradiated with ultraviolet rays at a dose of 1.0 J/cm² under air atmosphere to obtain a cured film with a thickness of 200 μm. The refractive index of the cured film at 25° C. was measured using an Abbe refractometer manufactured by Atago Co., Ltd. according to JIS K7105.

### 2. Evaluation of Transparency

The curable liquid composition was applied to a polyethyleneterephthalate (PET) film with a thickness of 125 μm by using an applicator bar to a thickness of 40 μm. The composition was exposed to ultraviolet rays at a dose of 250 mJ/cm² in nitrogen atmosphere to obtain a cured film. Appearance and transparency of the resulting cured film were observed to evaluate the presence or absence of unusual matter and abnormalities such as coating unevenness, repellency, whiteness, etc. The samples exhibiting such abnormalities were rated as Good, otherwise the samples were rated as Bad.

### 3. Evaluation of Heat Resistance

Cured films were obtained in the same manner as in the transparency evaluation. The sample was cut into a square of 1 cm×1 cm. A column-shaped quartz stick with a diameter of 5 mm was pressed against the test specimen at a load of 20 gf using a thermal mechanical analysis (TMA) system (manufactured by Seiko Instruments Inc.) while changing the temperature to measure the amount of displacement of the thickness of the test specimen. The temperature increase rate was 5° C./min. The amount of displacement increases as the temperature increases. The inflection point at which the amount of displacement decreases was measured as the softening point. If the inflection point is less than 50° C., when forming a lens sheet using the curable composition of the present invention, the shape of the lens may deform at high temperature. Therefore, the case where the inflection point was less than 50° C. was judged as “Bad”, the case where the inflection point was 50° C. or more but less than 60° C. was judged as “Good”, and the case where the inflection point was more than 60° C. was judged as “Excellent”.

The measurement was performed after heating the cured film at 60° C. for three days immediately after irradiation with ultraviolet rays.

### 4. Measurement of Warping

Cured films were obtained in the same manner as in the transparency evaluation. The sample was cut into a square of 8 cm×8 cm and placed on a flat desk with the cured film on the upper side. The height of the four corners of the sample from the desk was measured. The average value of the height was defined as the amount of warping. If the amount of warping exceeds 20 mm, when forming a lens sheet using the curable composition of the present invention, optical characteristics such as brightness may be impaired due to curling of the lens.

Therefore, a case where the amount of warping exceeded 20 mm was judged as “Bad”, and a case where the amount of warping was 20 mm or less was judged as “Good”, and a case where the amount of warping was 10 mm or less was judged as “Excellent”.

The measurement was performed after heating the cured film at 60° C. for three days immediately after irradiation with ultraviolet rays, and heating the cured film at 85° C. for 30 minutes.

The results are shown in Table 1.

TABLE 1

| | | Example | | Comparative Example | | | |
|---|---|---|---|---|---|---|---|
| | | 1 | 2 | 1 | 2 | 3 | 4 |
| Component (A) | Neopole V779MA | 35 | 35 | 35 | 35 | 35 | |
| | Neopole V779 | | | | | | 35 |
| | New Frontier PHE | 15.5 | 15.5 | 15.5 | 15.5 | 15.5 | 15.5 |
| | New Frontier BR31 | 13 | 13 | 13 | 13 | 13 | 13 |
| Component (B) | Aronix M315 | 5.5 | 5.5 | 5.5 | 5.5 | 5.5 | 5.5 |
| Component (C) | Irgacure 184 | 3 | 3 | 3 | 3 | 3 | 3 |
| Component (D) | PLACCEL CD220PL | 2 | 5 | | | | 2 |
| Other | 1,9-Nonanediol diacrylate | 5 | 5 | 5 | 5 | 5 | 5 |
| components | Acryloylmorpholine | 16 | 16 | 16 | 16 | 16 | 16 |
| | Urethane acrylate | 10 | 10 | 10 | 10 | 10 | 10 |
| | PLACCEL CD210PL | | | | 2 | | |
| | DA2000 | | | | | 2 | |
| Methacrylate compounds in the total acrylic components (wt %) | | 35 | 35 | 35 | 35 | 35 | 0 |
| Total amount | | 105 | 108 | 103 | 105 | 105 | 105 |
| Properties of | Refractive index | 1.57 | 1.50 | 1.57 | 1.57 | 1.57 | 1.57 |
| cured product | Transparency | Good | Good | Good | Good | Good | Good |
| | Heating resistance | | | | | | |
| | After UV irradiation | Good | Good | Good | Good | Good | Good |
| | After heating | Excellent | Excellent | Good | Good | Good | Good |
| | Warping | | | | | | |
| | After preparation (including processing) | Excellent | Excellent | Good | Good | Good | Good |
| | After heating at 85° C. for 30 minutes | Excellent | Excellent | Good | Good | Good | Good |

Neopole V779 (manufactured by Japan U-PiCA Co., Ltd.): tetrabromobisphenol A epoxy acrylate
Neopole V779MA (manufactured by Japan U-PiCA Co., Ltd.): tetrabromobisphenol A epoxy methacrylate
New Frontier PHE (manufactured by Daiichi Kogyo Seiyaku Co., Ltd.): phenoxyethyl acrylate
New Frontier BR31 (manufactured by Daiichi Kogyo Seiyaku Co., Ltd.): tribromophenoxyethyl acrylate
Aronix M315 (manufactured by Toagosei Co., Ltd.): tris(acryloylethyl) isocyanurate
Irgacure 184 (manufactured by Ciba Specialty Chemicals Co., Ltd.): 1-hydroxycyclohexyl phenyl ketone
PLACCEL CD220PL (manufactured by Daicel Chemical Industries, Ltd.): Polycarbonate diol (hydroxyl value: 51-61)
PLACCEL CD210PL (manufactured by Daicel Chemical Industries, Ltd.): Polycarbonate diol (hydroxyl value: 107-117)
DA2000 (manufactured by Nippon Oil and Fats Co., Ltd.): Polyether diol

As is clear from Table 1, the cured product of the composition of the present invention containing the components (A), (B), and (C) excels in heat resistance, shows a small amount of warping and deformation, and has a refractive index as high as 1.55 or more. Therefore, the cured product is particularly useful as an optical part.

1. A photocurable composition comprising the following components (A) to (D):
(A) at least one of (meth)acrylates having structures shown by the following formulas (1) and (2), 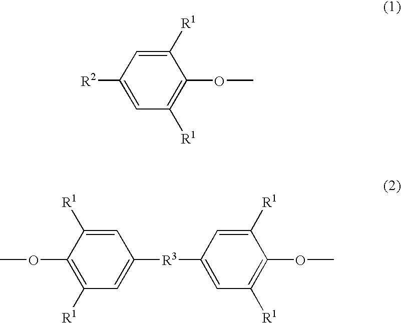
wherein R¹ represents a hydrogen atom or a halogen atom excluding a fluorine atom, R² is a hydrogen atom, a halogen atom excluding a fluorine atom, Ph-C(CH₃)₂—, Ph-, or an alkyl group having 1-20 carbon atoms, and R³ represents —CH₂—, —S—, or —C(CH₃)₂—;
(B) a (meth)acrylate having three or more functional groups, excluding the (meth)acrylates of the component (A);
(C) a radical photoinitiator; and
(D) a polycarbonate polyol having a hydroxyl value of 10-100;
wherein 5-50 wt % of the total acrylic components in the composition are methacrylate compounds.

2. The photocurable composition according to claim 1, wherein a cured product of the composition has a refractive index of 1.55 or more at 25° C.

3. The photocurable composition according to claim 1, wherein a cured product of the composition has a softening point of 40° C. or more.

4. The photocurable composition according to claim 1, which is used to form an optical part.

5. An optical part obtained by curing the composition according to.
